(19) United States
(12) Patent Application Publication
(10) Pub. No.: US 2024/0150058 A1
(43) Pub. Date: May 9, 2024

(54) Method for the low-germ packaging of vegan cheese

(71) Applicant: DMK Deutsches Milchkontor GmbH, Zeven (DE)

(72) Inventor: Georg-Wilhelm BEIDENHAUSER, Rastede (DE)

(21) Appl. No.: 18/504,366

(22) Filed: Nov. 8, 2023

(30) Foreign Application Priority Data
Nov. 8, 2022 (EP) 22205966.9

(51) Int. Cl. B65B 63/08; B65B 3/04; B65B 7/02

(52) U.S. Cl. CPC B65B 63/08; B65B 3/045; B65B 7/02; B65B 2220/24

(57) ABSTRACT

The proposal is for a method for the low-germ packaging of vegan cheese, comprising or consisting of the following steps:
(a) preparing vegan cheese in a heated buffer container, the temperature of which is sufficient to keep the vegan cheese in a liquid state;
(b) preparing a film bag, in which the film webs are welded to one another in such a way that they form a rectangle during filling, wherein the film bag has a filling nozzle with a closure cap;
(c) filling the film bag with the vegan cheese from the buffer container via the filling nozzle until the bag has assumed its rectangular shape;
(d) closing the bag with the closure cap, and
(e) cooling the cheese mass, optionally in a shape corresponding to the rectangle.

### FIELD OF THE INVENTION

The present invention is in the sector of the packaging industry and relates to a method for producing a special low-germ packaging.

### TECHNOLOGICAL BACKGROUND

Low-germ packaging of cheese is unproblematic in practice since it is necessary to package a fixed mass, which is protected from harmful germs by a natural bacteria flora. However, in the case of vegan cheese products, this protective flora is lacking, making them susceptible to infection by germs, especially since filling takes place in the liquid form, i.e. the mass hardens in the package or in a mold before packaging.

Liquid products which are supposed to harden in the package have hitherto usually been introduced into “pillows”. This is a tubular package in which two film webs are welded at the sides and which is then cut in sections and welded together again at the edges. The products solidify in the films in the typical pillow shape. This is disadvantageous for two reasons: because of its irregular shape, the packaging is unsuitable for further processing and, furthermore, the film easily forms creases, which often makes it difficult to remove the film. Other methods are filling deep-drawn packages which contain a product that is exposed during the filling process and which allow only low filling temperatures, and filling a synthetic skin, although this gives only a rod shape. Here too, filling is only possible at low temperatures.

### PRIOR ART

EP 0008961 B1 (MORIN SA) relates to a cellulose packaging film for packaging with a controlled permeability for oxygen, carbon dioxide, ammonia and steam, which makes it possible for the cheese to mature properly while it is wrapped in the packaging material. The cellulose packaging film is formed by a cellulose film substrate with a covering layer composed of a nitrocellulose coat in which casein or starch particles are distributed, the diameter of which is greater than the thickness of the covering layer. In use, the soft cheese is enclosed by the cellulose packaging film, wherein the nitrocellulose coating layer faces the soft cheese

EP 0025431 B1 (TEICH AG) claims a packaging material for the production of packaging, in particular for soft cheese, which has an air permeable base material (1), in particular a perforated foil, which is bonded on the inside of the packaging to a barrier material containing a polyolefin layer, wherein, for wrapping packaging, the base material is bonded to the barrier material only in defined areas which occupy only a small portion of its surface area.

EP 0128963 B1 (NESTLE) relates to a method for producing and packaging portions of spreadable foodstuffs, e.g. various types of processed cheese, in a number of layers. In this case, the layers are shaped individually in molding compartments by keeping them separate and, while ejecting them, guiding them individually onto the bottom of a preshaped shell, wherein substantially all traces of spread are removed from the molding compartments.

EP 3620060 B1 (HOCHLAND) relates to a method for producing a vegan cheese substitute, in which said cheese substitute is packed in a sleeve which consists of a plastic layer and/or a metal layer and has a barrier effect with respect to the passage of moisture and/or oxygen.

### OBJECT OF THE INVENTION

The object of the present invention was therefore to make available a method which ensures the germ-free hot packaging of vegan cheese and, at the same time delivers a product which can be processed further without additional steps.

### DESCRIPTION OF THE INVENTION

The invention relates to a method for the low-germ packaging of vegan cheese, comprising or consisting of the following steps:
(a) preparing vegan cheese in a heated buffer container, the temperature of which is sufficient to keep the vegan cheese in a liquid state;
(b) preparing a film bag, in which the film webs are welded to one another in such a way that they form a rectangle during filling, wherein the film bag has a filling nozzle with a closure cap;
(c) filling the film bag with the vegan cheese from the buffer container via the filling nozzle until the bag has assumed its rectangular shape, and
(d) closing the bag with the closure cap, and
(e) cooling the cheese mass, optionally in a shape corresponding to the rectangle.

Dispensing the hot vegan cheese substitute, after production, from a buffer container into a film bag in which the film webs are welded to one another in such a way that they do not have an irregular shape during filling but form a cuboid ensures that the process takes place under sterile conditions and, at the same time, that a preshaped product which allows further processing by the customer without problems is obtained. Hardening into a cuboid can preferably be promoted by placing the package in a corresponding mold. The bag is filled via a filling nozzle (“spout”) which has a closure cap and, after filling, can be closed in such a way that it can no longer be opened. This also protects the product from accidental contamination and ensures that it is packaged in its original condition.

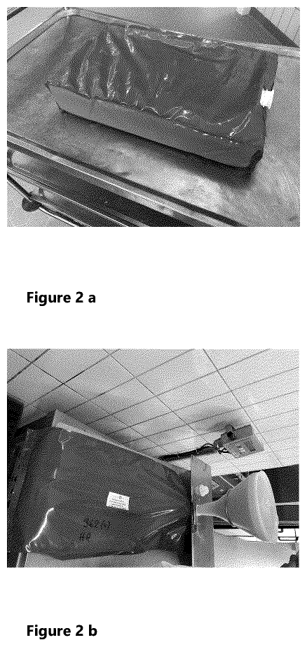

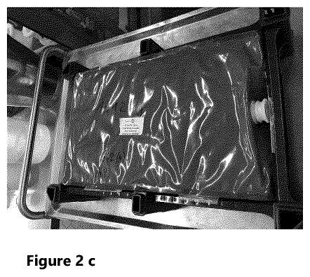

A suitable material for production of the film bag is, in particular, linear low density polyethylene (LLDPE) which can be in the form of a multi-ply laminate and, at the same time, can also have layers consisting of other plastics. One preferred product is the Cheertainer 15 L BLUE SB Multi 30 Plug IR by QuadPack, which forms a laminate consisting of four layers, namely (from the inside out) Blue LLDPE (52 μm), EVOH (6 μm), Blue LLDPE (52 μm) and OPA (15 μm). FIG. 2 shows a film bag before, during and after filling.

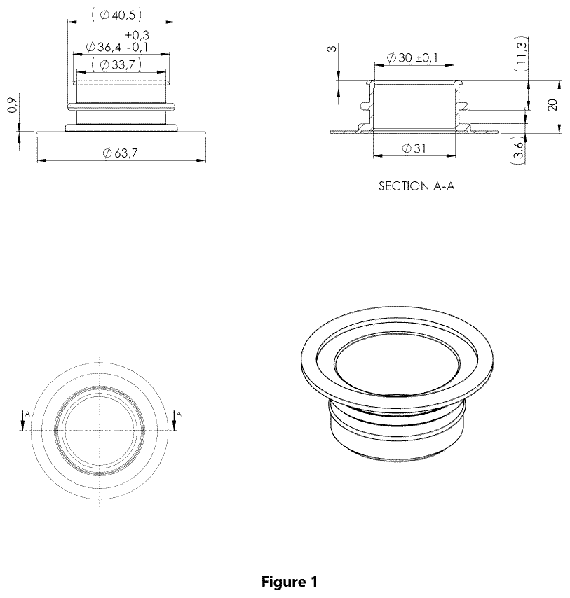

The filling nozzles with the closure cap are likewise commercially available. Types which are sold by Modulpac AB are particularly suitable (for details, see FIG. 1).

1. A method for the low-germ packaging of vegan cheese, comprising or consisting of the following steps:
(a) preparing vegan cheese in a heated buffer container, the temperature of which is sufficient to keep the vegan cheese in a liquid state;
(b) preparing a film bag, in which the film webs are welded to one another in such a way that they form a rectangle during filling, wherein the film bag has a filling nozzle with a closure cap;
(c) filling the film bag with the vegan cheese from the buffer container via the filling nozzle until the bag has assumed its rectangular shape, and
(d) closing the bag with the closure cap, and
(e) cooling the cheese mass, optionally in a shape corresponding to the rectangle.

2. The method as claimed in claim 1, characterized in that the rectangular shape of the packaging corresponds to the Euroblock format for cheese blocks.

3. The method as claimed in claim 1, characterized in that film bags composed entirely or partially of LLDPE are used.

4. The method as claimed in claim 1, characterized in that film bags which have a plurality of layers of plastic are used.
